(19) United States
(12) Patent Application Publication
(10) Pub. No.: US 2014/0272503 A1
(43) Pub. Date: Sep. 18, 2014

(54) DROP AND VIBRATION RESISTANT ELECTROCHEMICAL CELL

(71) Applicant: SAFT, (US)

(72) Inventors: Daniel KELLEY, York, PA (US); Bridget DEVENEY, Baltimore, MD (US); David ADDISON, Baltimore, MD (US)

(73) Assignee: SAFT, Bagnolet (FR)

(21) Appl. No.: 13/835,263

(22) Filed: Mar. 15, 2013

(51) Int. Cl. H01M 10/04

(52) U.S. Cl. CPC H01M 10/0431
USPC 429/94; 29/623.1; 29/623.4

(57) ABSTRACT

An electrochemical cell including an electrode assembly including a winding core, a first electrode, a second electrode, and a separator, the first electrode, the second electrode, and the separator being wound around the winding core, a current collector connected to the first electrode, and a case that accommodates the wound electrode assembly and the current collector. The winding core is welded to the current collector.

### BACKGROUND OF THE INVENTION

1. Field of the Invention

The current disclosure relates to an electrochemical cell, including, without limitation, an electrochemical cell that is drop and vibration resistant.

2. Background

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Some conventional electrochemical cells include an electrode assembly (jelly roll) disposed inside of a case. These types of cells are vulnerable to various mechanical abuses, in particular shock and vibration.

That is, in certain applications, electrochemical cells are exposed to very high levels of vibration and/or mechanical shock, e.g. a space shuttle launching process. Such vibration or shock may cause the electrode assembly to move within the case causing the cell to fail due to, for example, breakage of welds within the cell, damage to the electrode material, bulging of the case and electrolyte leakage.

### SUMMARY

The present invention provides a drop and vibration resistant lithium ion battery that is able to survive severe vibration and mechanical shock conditions.

A first exemplary aspect of the present disclosure includes an electrochemical cell including an electrode assembly including a winding core, a first electrode, a second electrode, and a separator, the first electrode, the second electrode, and the separator being wound around the winding core, a current collector connected to the first electrode, a case that accommodates the wound electrode assembly and the current collector. The winding core is welded to the current collector which may be welded to the case.

A second exemplary aspect of the present disclosure includes an electrochemical cell including a winding core extending in an axial direction, an electrode assembly including a first electrode and a second electrode wound around an outer circumference of the winding core, the wound electrode assembly having a first diameter, a case extending in the axial direction and having a second diameter that is greater than the first diameter, the case being configured to accommodate the wound electrode assembly. The winding core is mechanically fixed to the case.

A third exemplary aspect of the present disclosure includes a method of making an electrochemical cell. The method includes welding a current collector to a winding core of an electrode assembly, inserting the wound electrode assembly into a case, and disposing a material, which swells, between the current collector and the case.

### DRAWINGS

FIG. 1 shows a perspective view of an electrochemical cell according to an exemplary embodiment;

FIG. 2 shows a partial cross-sectional view of a bottom portion of the electrochemical cell shown in FIG. 1;

FIG. 3 shows a partial cross-sectional view of electrodes and separators for an electrochemical cell according to an exemplary embodiment; and

FIG. 4 shows a detailed view of a current collector welded to the winding core according to an exemplary embodiment.

### DETAILED DESCRIPTION

Embodiments will be described below in more detail with reference to the accompanying drawings. The following detailed descriptions are provided to assist the reader in gaining a comprehensive understanding of the methods, apparatuses, and/or systems described herein and equivalent modifications thereof. Accordingly, various changes, modifications, and equivalents of the methods, apparatuses, and/or systems described herein will be apparent to those of ordinary skill in the art. Moreover, descriptions of well-known functions and constructions may be omitted for increased clarity and conciseness.

The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a part or combinations thereof, and shall not be construed to preclude any presence or possibility of one or more other characteristics, numbers, steps, operations, elements, parts or combinations thereof.

FIG. 1 shows a perspective view of an exemplary electrochemical cell 10. According to an exemplary embodiment, the cell 10 includes a container or case 12, a cap or cover 14, and a winding core or mandrel 24, and an electrode assembly 16 wound around the winding core 24.

The electrode assembly 16 is a wound electrode assembly, commonly known as a jelly roll, which includes at least one cathode or positive electrode 18, at least one anode or negative electrode 20, and one or more separators 22 that are wrapped around the winding core 24. The one or more separators 22 are provided intermediate or between the positive and negative electrodes 18, 20 to electrically isolate the electrodes from each other. According to an exemplary embodiment, the cell 10 includes an electrolyte (not shown) within the case 12. In addition, to securely retain the electrode assembly 16 in the case 12, the winding core 24 is welded to the current collector or bussing washer 26, as illustrated in FIG. 2. Also, a material 28, which swells when contacted by the electrolyte, may be provided between the outside of the electrode assembly 16 and the inside wall of the case 12 to snugly retain the electrode assembly 16 in the case 12. This aspect of the invention is discussed in greater detail below.

Although the winding core 24 is shown as being provided as having a generally cylindrical shape, according to other exemplary embodiments, the winding core 24 may have a different configuration (e.g., it may have an oval or rectangular cross-section shape, etc.). It is noted that the electrode assembly 16, although shown as having a generally cylindrical shape, may also have a different configuration (e.g., it may have an oval, rectangular, or other desired cross-section shape).

The positive electrode 18 is offset from the negative electrode 20 in the axial direction as shown in the partial cross-sectional view shown in FIG. 3. Accordingly, at a first end of the electrode assembly 16, the wound positive electrode 18 will extend further than the negative electrode 20, and at a second (opposite) end of the electrode assembly 16, the negative electrode 20 will extend further than the positive electrode 18. Accordingly, that current collectors may be connected to a specific electrode at one end of the cell without contacting the opposite polarity electrode.

FIG. 2 shows a partial cross-sectional view of the closed bottom portion of the electrochemical cell 10 including the current collector 26. The current collector 26 has an annular shape and fits over the end of the electrode assembly 16 such that it contacts either the positive electrode 18 or negative electrode 20 extending from the electrode assembly 16. The winding core 24 may be mechanically fixed to the case 12. Specifically, the center portion of the current collector 26 is welded to the end of the winding core 24 at weld 30, as shown in FIG. 4. The weld 30 is preferably annular as shown, but may instead include individual welds at different locations around the interface between the current collector 26 and the winding core 24. In addition, the current collector 26 may be welded to the case 12 at weld 32 or any other convenient location where the current collector 26 contacts the case 12 to thereby mechanically fix the winding core 24 to the case 12. Furthermore, in another exemplary embodiment, the winding core 24 is mechanically fixed to the case 12 directly welding the winding core 24 to the case 12. In this exemplary embodiment, electrochemical cell 10 may not include a current collector disposed between direct weld of the winding core 24 to the case 12. By virtue of these designs, the electrode assembly 16 is securely retained in the case 12 to improve its resistance to shock and vibration. The welds 30 and 32 may be made by, for example, laser welding, but any welding technique would suffice.

According to another exemplary embodiment, the current collector 26 may include an outer wall portion 34 that extends around the current collector 26 and has a diameter that is slightly larger than the inner diameter of the case 12. Prior to sealing the cover 14 to the top (first distal end) of the case 12, the top of the case 12 has an opening that is configured to receive the electrode assembly 16 and the current collector 26. When the current collector 26 is press-fit into the case 12, the current collector 26 radially displaces the case 12. In this manner, a pressure caused by the interference between the current collector 26 and the case 12 increases the inner diameter of the case 12 and decreases the diameter of the current collector 26. This further assists in stabilizing the electrode assembly 16 in the case 12.

As noted above, material 28 is provided around the outside of the jelly roll electrode assembly 16 such that it is sandwiched between the electrode assembly 16 and the case 12. The material 28 swells when the case 12 is filled with electrolyte to further secure the electrode assembly 16 in the case 12 and act as a cushion to shock or vibration. The material 28 may be such that when contacted by the electrolyte it also becomes sticky, thereby causing the electrode assembly 16 to adhere to the inner surface of the case 12 and further protect against high vibration and mechanical shock.

Examples of the swellable material 28 include a highly soluble polymer material, such as, for example, polyvinyldifluride (PVdF), a polymer compound including a functional atom group such as an ester group and a carboxyl group, carboxymethylcellulose (CMC), styrene butadiene rubber (SBR latex), ethylene-propylene-diene methylene linkage (EPDM), etc.

The material 28 may be applied to an outer circumference of the jelly roll electrode assembly 16. For example, according to one exemplary embodiment, the material 28 may be considered to be a tape that is adhered to the electrode assembly 16. Alternatively, the material 28 may also be a coating material that coats an outer circumference of the electrode assembly 16.

According to other exemplary embodiments, the material 28 may be applied to an inner surface of the case 12. For example, according to one exemplary embodiment, the material 28 is considered to be a tape that is provided on an inner surface of the case 11 between the case 11 and the electrode assembly 16. According to another exemplary embodiment, the material 28 is considered to be a coating material that is coated on an inner surface of the case 11 between the case 11 and the electrode assembly 16.

Exemplary embodiments described above are an improvement over the conventional electromechanical cells. For example, the inventors conducted a vibration test which demonstrated that the conventional cell, without the above described weld 30 and swellable material 28, failed after fifteen seconds when vibrated to 54 Gᵣₘₛ (root-mean-square acceleration) in a single direction. In contrast, an exemplary electrochemical cell including the swellable material 28 and the current collector 26 welded to the winding core 24 at weld 30 survived six minutes under the same vibration parameters, well beyond a three minute per vibration direction threshold needed in some high vibration applications.

More specifically, lithium ion cells were vibration tested in the Z (parallel to the axis of the cell) axis to a customer-specific profile with amplitude 54 Gᵣₘₛ. The cells were mounted into a rigid aluminum block by way of resin potting thereby connecting the cell case wall to the rigid block. The rigid block was then mounted directly to a vibration armature and the testing was completed at room temperature. The fixtures and cells were affixed with accelerometers, where possible, and the cells were monitored for voltage drop during the test in order to determine if a disconnect had occurred within the cell. The testing was continued for 3 minutes in the Z axis or until a failure occurred. If no failure occurred, the testing was repeated for X and Y axes (perpendicular axes perpendicular to the axis of the cell). Conventional cells without the above-mentioned features failed due to electrical disconnect consistently at roughly 15 seconds into the vibration testing. Constraining the top and bottom of the conventional cells externally (mimicking a thick cover and case bottom) extended the runtime to two minutes (120 seconds) when implemented on a conventional cell (still not meeting the 3 minute requirement needed in some high vibration applications). However, when the above-mentioned vibration testing was implemented on multiple exemplary electrochemical cells, each including the swellable material 28 and the current collector 26 welded to the winding core 24 at weld 30, each saw an in increase in longevity without electrical disconnect during the vibration testing. Specifically, each of the exemplary electrochemical cells was able to withstand the 3 minutes of 54 Gᵣₘₛ vibration testing in each of three mutually-perpendicular axes. During this testing at three minutes per axis, the exemplary electrochemical cells did not show voltage fluctuations which would indicate a cell disconnect internally.

Although the inventive concept has been described above with respect to the various embodiments, it is noted that there can be a variety of permutations and modifications of the described features by those who are familiar with this field, without departing from the technical ideas and scope of the features, which shall be defined by the appended claims.

Further, while this specification contains many features, the features should not be construed as limitations on the scope of the disclosure or the appended claims. Certain features described in the context of separate embodiments can also be implemented in combination. Conversely, various features described in the context of a single embodiment can also be implemented in multiple embodiments separately or in any suitable sub-combination.

There is claimed:

1. An electrochemical cell comprising:
an electrode assembly comprising a winding core, a first electrode, a second electrode, and a separator, the first electrode, the second electrode and the separator being wound around the winding core;
a current collector connected to the first electrode; and
a case that accommodates the wound electrode assembly and the current collector,
wherein the winding core is welded to the current collector.

2. The electrochemical cell according to claim 1
wherein the current collector is welded to the case.

3. The electrochemical cell according to claim 1, further comprising a material disposed between an inner surface of the case and the wound electrode assembly, wherein
the material swells in response to the case being filled with electrolyte.

4. The electrochemical cell according to claim 3, wherein the material is a tape wrapped around the wound electrode assembly that adheres to the case in response to being contacted by the electrolyte.

5. The electrochemical cell according to claim 3, wherein the material coats an outer circumference of the wound electrode assembly.

6. The electrochemical cell according to claim 5, wherein the material adheres to the case in response to being contacted by the electrolyte.

7. The electrochemical cell according to claim 1, wherein the current collector includes an outer edge that is distal to the weld between the current collector and the winding core.

8. The electrochemical cell according to claim 1, wherein the case includes a first distal end having an opening that is configured to receive the wound electrode assembly and the current collector, and the current collector radially displaces the case when the current collector is inserted into the case.

9. The electrochemical cell according to claim 8, wherein the current collector has a circumference that is greater than a circumference of the wound electrode assembly and less than a circumference of an inner portion of the case.

10. An electrochemical cell including:
a winding core extending in an axial direction;
an electrode assembly including a first electrode and a second electrode wound around an outer circumference of the winding core, the wound electrode assembly having a first diameter;
a case extending in the axial direction and having a second diameter that is greater than the first diameter, the case being configured to accommodate the wound electrode assembly; and
wherein the winding core is mechanically fixed to the case.

11. The electrochemical cell according to claim 10, further comprising:
a material disposed between the wound electrode assembly and the case, wherein
in response to electrolyte being introduced into the case, the material swells and causes the wound electrode assembly to adhere to an inner surface of the case.

12. The electrochemical cell according to claim 10, further comprising a current collector welded to the winding core.

13. The electrochemical cell according to claim 12, wherein the current collector is further welded to an inner surface of the case to thereby mechanically fix the winding core to the case.

14. A method of making an electrochemical cell, the method comprising:
welding a current collector to a winding core of an electrode assembly;
inserting the wound electrode assembly into a case; and
disposing a material, which swells between the current collector and the case.

15. The method of making an electrochemical cell according to claim 14, wherein the material becomes adhesive in response to electrolyte.

16. The method of making an electrochemical cell according to claim 14, wherein disposing the material comprises applying the material to the wound electrode assembly.

17. The method of making an electrochemical cell according to claim 14, wherein disposing the material comprises applying the material to an inner surface of the case.

18. The method of making an electrochemical cell according to claim 14, wherein the current collector has a diameter that is greater than an inner diameter of the case, and
inserting the wound electrode assembly into the case comprises press-fitting the wound electrode assembly into the case so that the current collector radially displaces the case.

19. The method of making an electrochemical cell according to claim 14, further comprising welding the current collector to an inner surface of the case.
